(19) United States
(12) Patent Application Publication
(10) Pub. No.: US 2005/0134449 A1
(43) Pub. Date: Jun. 23, 2005

(54) Two stage radio frequency identification

(75) Inventors: Steven E. Barile, Portland, OR (US); Anthony C. Salvador, Portland, OR (US); Tim L. Brooke, Portland, OR (US)

Correspondence Address: VENABLE, BAETJER, HOWARD AND CIVILETTI, LLP, P.O. BOX 34385, WASHINGTON, DC, 20043-9998, US

(73) Assignee: Intel Corporation, Santa Clara, CA (US)

(21) Appl. No.: 10/737,928

(22) Filed: Dec. 18, 2003

(51) Int. Cl. G08B 26/00

(52) U.S. Cl. 340/505

(57) ABSTRACT

Two levels of RFID interrogation may be used to provide verification.

### BACKGROUND OF THE INVENTION

Radio Frequency Identification (RFID) is being used increasingly as a means to identify goods at a distance, without requiring physical contact or even line of sight access to the goods. RFID enables information about an item to be stored on an item, and in some implementations also allows this stored information to be modified at a distance. RFID technology provides an alternative to bar code reader technology for distinguishing and recording items for purchase. RFID tags may be permanently or temporarily attached to items available for purchase in a store. The RFID tags can store information regarding the item, such as description, cost, inventory number, etc. Customers entering and exiting the store may also be carrying RFID tags. The customer's RFID tag can take the form of a smart credit card, loyalty card, and the like. These RFID tags may be detected by RFID interrogators within the store.

The RFID interrogators are typically arranged at an exit to the store. When a customer selects an item for purchase, the customer simply needs to pass in the vicinity of an RFID interrogator as they exit the store. The RFID interrogator can read item information from the RFID tag on a product and read the customer information from the RFID tag of the customer. A purchase transaction can then be automatically completed without the necessity to pause at a check out register or other counter. Although quick and convenient, some consumers have a psychological prejudice against this system. For example, some consumers require proof or verification from the store that the consumer has actually purchased the goods. These consumers want some kind of receipt or other written verification of their purchase. Additionally, consumers have a fear of being confronted by store security personnel if they simply pick up an item and walk out of the store.

The system described above also presents some concerns for retailers. If the RFID interrogator is placed close to the exit of a store, store security personnel have very little time to react if a theft is detected. A customer may exit a store before store security can stop the customer. The retailer faces much higher legal liability if a customer is confronted regarding theft after the customer has exited the store. Additionally, if there is a problem with the transaction, the problem is first detected as the customer is exiting the store. Again, this presents the problem of having to chase down the customer outside of the store or in the store parking lot in order to remedy the problem.

### BRIEF DESCRIPTION OF THE DRAWINGS

The invention may be understood by referring to the following description and accompanying drawings, wherein like reference numbers generally indicate identical, functionally similar, and/or structurally similar elements.

FIG. 1 illustrates a system according to an embodiment of the invention;

FIG. 2 is an exemplary layout of a system according to an embodiment of the invention; and

FIG. 3 is a flow chart of a method according to an embodiment of the invention.

### DETAILED DESCRIPTION OF EXEMPLARY EMBODIMENTS OF THE PRESENT INVENTION

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

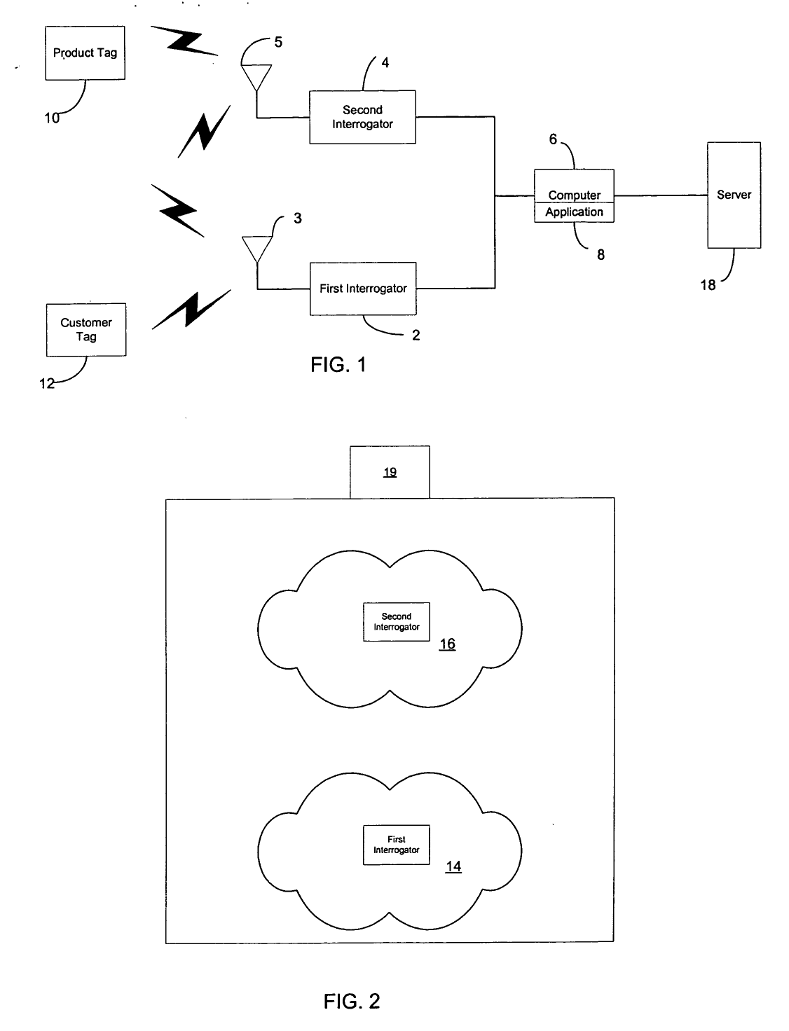

FIG. 1 is a block diagram illustrating a transaction system according to an embodiment of the invention. The system may include first and second RFID interrogator units 2, 4. The interrogator units 2, 4 preferably may include an antenna 3, 5 as well as dedicated transmitting and receiving circuitry. A controller may be provided to control the interrogators and process information, as well as perform other functions. The controller may include computer 6 and server 18. The computer 6 may be in communication with the interrogators. The computer may include an application program 8 for controlling the interrogators 2, 4 and interpreting responses. The interrogators may be used to transmit and receive signals from RFID tags. The RFID tags may include a product or item tag 10 and a customer or personnel tag 12. The RFID tags 10, 12 may include a circuit such as an integrated circuit, a power source connected to the circuit to supply power thereto, and at least one antenna connected to the integrated circuit for radio frequency transmission and reception by the circuit. Alternatively, the tags may be “passive” tags which do not require a power source. The RFID tags may store identification information, or example, information about an item or about an individual or organization. The product tag 10 and customer tag 12 may store product and customer or consumer identifiers, respectively, and various other information regarding the product and the consumer. For example, the product tag 10 may include data fields for storing a date and time of a purchase, a location of the purchase, the seller, the current owner of the item, and the original or original equipment manufacturer (OEM) owner of the item. The product tag may be readable and writable. The customer tag 12 may include at least information identifying the customer, such as a credit card number, name, etc. Although called product tags and customer tags, these terms encompass any RFID tag that includes information that may be used to identify that tag.

The first and second interrogators 2, 4 may transmit an interrogation signal or command via their antennas 3, 5 to product tags and customer tags in the vicinity. A plurality of first or second interrogators may be provided, depending on the specific implementation. The first interrogator 2 may transmit an interrogation signal in a first area 14 in a retail store, as shown in FIG. 2. The first area 14 may be interior with respect to the second interrogator 4. FIG. 2 illustrates an exemplary layout of a store. The first area 14 may be a checkout area similar to typical checkout areas and may include a cash register and a counter. The first interrogator 2 may be used to complete purchase transactions. The first area 14 may also include a product return area, customer service area, etc., in which case the first interrogator 2 may be used to complete associated transactions. Most likely the first area may simply be a designated area of the store where the first interrogator 2 may be located.

The second interrogator 4 may transmit an interrogation signal in a second area 16 of the store. The second area may be near an exit 19 of the retail store. The first and second interrogators 2, 4 may be arranged so that a customer may need to first pass through the first area 14 and then through the second area 16 in order to exit the store. The first and second areas 14, 16 may or may not overlap. As customers pass by the second interrogator 4 to exit the store, the second interrogator 4 may be used to read purchase or ownership information from products to ensure that the products have been paid for. The second interrogator 4 may be arranged sufficiently far from the exit 19 of the store to allow security personnel to take appropriate actions if a stolen item or other problem is detected.

The product tags 10 and customer tags 12 may receive the incoming interrogation signals from the first and second interrogators 2, 4 via their respective antennas. Upon receiving an interrogation signal, the product tag 10 and customer, tag 12 may respond by generating and transmitting a return signal or reply. Preferably, the return signal provided by the tags may be encoded with information that uniquely identifies the transmitting tag. This may allow the interrogators to determine if the return signal is from a product tag or a customer tag, as well as to easily identify the item or person with which the tag is associated.

As mentioned above, the computer 6 may communicate with the first and second interrogators 2, 4. The computer 6 may execute an application program 8 that may decode the return signals from the tags and extract information therefrom. The return signals may have a specified format. For example, a product identifier may be provided in a first data field, followed by a second data field for owner information, etc. The application program may be tailored to interpret the return signals based on the specified format to obtain various data from the return signal, such as the location of the purchase, seller, price, etc. The application program may then process this information. The computer 6 may be connected to the retail store's inventory or other backend systems via server 18. This allows the computer 6 to complete a purchase transaction, return transaction, and other transactions automatically.

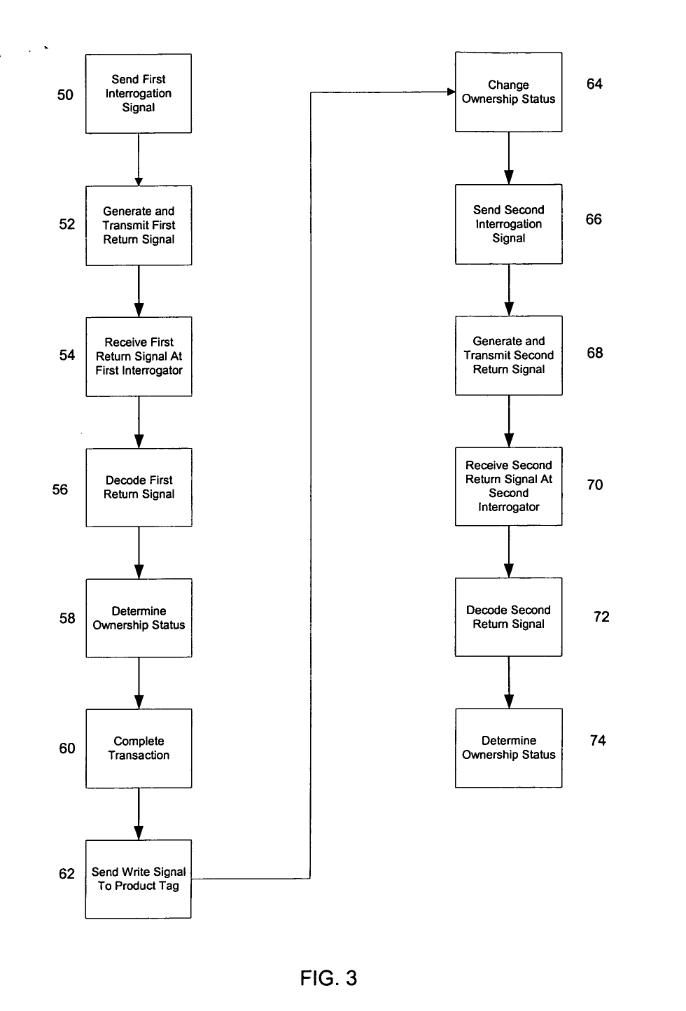

FIG. 3 is a flow diagram illustrating a method according to an exemplary embodiment of the present invention. The exemplary method is described in connection with a purchase transaction, but is equally applicable to product returns and other transactions, as well as to different environments for general identification purposes. As mentioned above, the first and second interrogators 2, 4 may be arranged in a retail store. At least some products for sale in the store may have a product tag 10 permanently or temporarily attached thereto. A customer of the retail store may have a customer tag 12. The customer may select a product having a product tag 10 for purchase and proceed to a checkout area in the store. The checkout area may be defined as an area in which the first interrogator can communicate with the product tag and the customer tag, such as first area 14. The customer may proceed with the product to the checkout area to make a purchase.

The first interrogator may send out a first interrogation signal in the checkout area, block 50. The interrogation signal may be sent out in response to a user command, may be triggered by a sensor or initiated by the computer. The first interrogation signal may include a request for specific information or it may be a general request. The first interrogation signal may be received by all tags, both product tags and customer tags 12, within the checkout area. A separate interrogation signal may be generated for each type of tag. At a minimum, the first interrogation signal may request ownership status information from the product tag and may request identification information from the customer tag. In response to the interrogation signal, the tags may generate and transmit a return signal to the first interrogator 2, block 52. The return signal may include specific information requested in the first interrogation signal, or it may be a general reply that supplies predetermined information no matter what information is requested by the interrogation signal. The return signal from the product tag 10 may include, but may not be limited to, ownership information for the product. As mentioned above, a specific data field may be provided in the product tag 10 to store the ownership information. The product tag 10 may locate the ownership information and transmit a return signal including the ownership information. The return signal generated and transmitted by the customer tag 12 may include identification information such as, but not limited to, the customer's name, address, credit card number, account number, or other types of information.

The first interrogator 2 may receive return signals from the product tags 10 and the customer tags 12 in the checkout area, block 54. The return signals from the product tag 10 and the customer tag 12 may be provided from the first interrogator 2 to the computer 6 for decoding, block 56. The computer 6 may decode the return signal from the product tag 10 to extract information therefrom. The information may include an ownership status of the product, block 58. The ownership status may indicate the current owner of the product as well as past owners such as manufacturers, distributors, etc. Ownership status may also indicate the chain of control of an item, without a change in who “owns” the item. The ownership status may indicate that the product is currently owned by the store. Accordingly, the computer 6 may deduce that the product is being presented for purchase. The ownership status may indicate that the customer is the owner of the product. This may be the case when the product was previously purchased from the store. In that case, no further action may be necessary for that product. The return signal from the product tag 12 may also include other information such as, but not limited to, a product identifier, price, etc. that may be used to complete the purchase transaction. If the return signal does not include the price or other information needed to complete the transaction, the computer 6 may interface with server 18 in order to determine the necessary information.

As mentioned above, the computer 6 may also decode the return signal from the customer tag 12 to extract information therefrom. The information from the customer tag 12 may include customer information such as, but not limited to, a credit card number, account number, name, address, etc, block 58. If the return signal does not include the information needed to complete the transaction, the computer 6 may interface with server 18 in order to determine the necessary information. The information from the customer tag 10 may be used to charge the customer for the product. Payment from the customer may be in the form of cash, check, credit card, debit card, store account, etc. Payment information may be obtained from the customer information received from customer tag, for example, a credit card number or may be provided by the customer. Payment may be considered to be received once the cash is accepted or the credit card or other electronic transaction is approved. Receipt of the payment may be indicated to the computer 6. This may be accomplished by an operator input or the receipt of an authorization for an electronic transaction. Once receipt of payment is verified and the sale is completed, block 60, the computer 6 may control the first interrogator 2 to transmit a write signal to the product tag 10, block 62. The write signal may include instructions for the product tag 10 to modify the ownership status stored in the product tag 10 for the product. For example, the ownership status may be changed from the name of the store to the name of the customer. Setting a flag indicating that the product has been purchased, or other equivalent means may also indicate the ownership status. The product tag 10 may make the appropriate change to ownership status, block 64.

During the purchase transaction process at the first interrogator 2, any problems with the transaction and/or verifications may be handled. A store employee may be present in the checkout area to handle such problems. For example, there may be a discrepancy between the price that is marked on an item and the price determined at the checkout area. A store employee may be alerted to this fact and may take the appropriate action. Additionally, an item may have been previously stolen from this or another store. The computer may determine the status of the item based on information in the return signal or based on a check of a product identifier in the store database via server 18. Again, store personnel may be alerted, and appropriate action may be taken.

After the transaction is completed, the customer may take the purchased products and proceed to the store exit. The second interrogator 4 may be arranged in the vicinity of the store exit. The second interrogator 4 may ideally be spaced far enough from the exit to allow store personnel to stop the customer before the customer exits the store if a problem is detected. Similar to the first interrogator 2, the second interrogator 4 may send out a second interrogation signal from its antenna into the second area 16, block 66. The second interrogation signal may be sent out in response to a user command, may be triggered by sensor, or initiated by the computer. The second interrogation signal may include a request for specific information, or it may be a general request. Product tags 10 within the second area 16 in the vicinity of the second interrogator 4 may receive the second interrogation signal. The second interrogation signal may request ownership information from the product tag 10. Upon receipt of the second interrogation signal, the product tag 10 may respond by generating and transmitting a second return signal, block 68. The second return signal from the product tag 10 may include, but may not be limited to ownership information for the product. As mentioned above, a specific data field may be provided in the product tag 10 to store the ownership information. The product tag 10 may locate the ownership information and may transmit a return signal including the ownership information to the second interrogator 4.

The second return signal may be received by the second interrogator, block 70. The second interrogator 4 may provide the second return signal to the computer 6 for decoding. The computer 6 may decode the second return signal to determine the ownership status of the product, blocks 72, 74. The ownership status may indicate that the product is still owned by the store or that the customer or third party owns the product. If the ownership status indicates that the product is owned by the store, the customer may be attempting to steal the product, or there may have been a problem with the purchase transaction. In any event, the computer may initiate the appropriate measures to alert store personnel. Store personnel may then take appropriate action while the customer and the product are still in the store.

Additionally, the second interrogator 4 may obtain information from the customer tag 12. As mentioned above, the customer information may be written into the product tag 10 when the product is purchased. The second return signal may be decoded to determine if the ownership information in the product tag 10 matches the ownership information in the customer tag 12. If the ownership information does not match, the computer 6 may initiate the appropriate steps to alert store personnel.

The first interrogation unit 2 may also be used to handle product returns and other transactions. For example, as a customer brings a product back to the store, the first interrogation unit 2 and computer 6 may query the product tag 10 to determine the ownership status of the product and may query the customer tag 12 to determine customer identification. If the ownership status information indicates that the product was stolen, belongs to another customer, etc., store personnel may be alerted to take the appropriate action. The return may be accepted if the queries indicate that the customer returning the product matches the ownership information for the product. It may also be determined if other criteria for a return are met, such as, but not limited to, time limits, sales, original location of sale, etc. Original location of sale may include the same store or the same chain of stores.

The various processes and methods described herein may be performed by different entities without departing from the scope of the invention. For example, the process described as being performed by the controller may be implemented as hardware, firmware or software incorporated into the first or second interrogators. The embodiments illustrated and discussed in this specification are intended only to teach those skilled in the art the best way known to the inventors to make and use the invention. Nothing in this specification should be considered as limiting the scope of the present invention. The above-described embodiments of the invention may be modified or varied, and elements added or omitted, without departing from the invention, as appreciated by those skilled in the art in light of the above teachings. It is therefore to be understood that, within the scope of the claims and their equivalents, the invention may be practiced otherwise than as specifically described.

1. A method comprising:
decoding first signals received at a first interrogator from an item tag to determine at least an item identifier;
decoding second signals received at a first interrogator from an identification tag to determine at least an owner identifier;
causing a signal to be sent from the first interrogator to the item tag to change an ownership indicator in the item tag; and
decoding third signals received at a second interrogator from the item tag to determine at least the ownership indicator.

2. The method of claim 1, further comprising providing at least one of the first, second and third signals to a computer for decoding.

3. The method of claim 1, further comprising:
decoding fourth signals received at the second interrogator from the identification tag to determine the owner identifier.

4. The method of claim 3, further comprising changing the ownership indicator in the item tag to correspond to the owner identifier.

5. The method of claim 3, further comprising determining if the owner identifier included in the fourth signals corresponds to the ownership indicator in the third signals.

6. A method comprising:
sending a first interrogation signal from a first interrogator to a product tag for a product and to a customer tag;
receiving first return signals from the product tag;
receiving second return signals from the customer tag;
decoding the first and second return signals to determine information including at least an ownership status of the product and customer information;
completing a transaction based at least in part on the information;
sending a write signal to the product tag to change the ownership status for the product included in the transaction;
sending a second interrogation signal from a second interrogator to the product tag;
receiving a third return signal from the product tag; and
decoding the third return signal to determine at least the ownership status of the product.

7. The method of claim 6, further comprising sending separate first interrogation signals for the product tag and the customer tag.

8. The method of claim 6, further comprising providing the first, second and third return signals to a computer.

9. The method of claim 8, further comprising decoding the first, second and third return signals with the computer.

10. The method of claim 8, further comprising communicating with a server via the computer to obtain additional information to complete the transaction.

11. The method of claim 6, further comprising:
receiving a customer return signal from the customer tag at the second interrogator;
decoding the customer return signal to obtain a customer identifier; and
determining if the customer identifier corresponds to the ownership status.

12. An apparatus, comprising:
a first interrogator including an antenna adapted to transmit read and write signals to an RFID tag and to receive first tag signals from the RFID tag responsive to the read signal, the write signal including an instruction the change an ownership indicator in the RFID tag;
a second interrogator including an antenna adapted to transmit second read signals requesting the ownership indicator from the RFID tag and to receive second tag signals responsive to the read signal from the RFID tag; and
a controller adapted to receive the first tag signals from the first interrogator, to decode the first tag signals to determine the ownership indicator, to instruct the first interrogator to send the write signal to the RFID tag if a transaction is completed, to receive the second tag signals from the second interrogator, and to decode the second tag signals to determine the ownership indicator.

13. The apparatus of claim 12, wherein the controller comprises a computer and a server adapted to communicate with the computer.

14. The apparatus of claim 12, wherein the first interrogator is adapted to transmit a third read signal to a second RFID tag and receive third tag signals from the second RFID tag responsive to the third read signal, and wherein the write signal is based on a customer identifier included in the third tag signals from the second RFID tag.

15. The apparatus of claim 14, wherein the controller is adapted to receive the third tag signals from the first interrogator and to decode the third tag signals to determine the customer identifier.

16. An apparatus, comprising:
a controller adapted to receive first tag signals from an item tag via a first interrogator, to decode the first tag signals to determine ownership information, to send a write signal to the item tag via the first interrogator altering the ownership information if a transaction is completed, to receive second tag signals from the item tag via a second interrogator, and to decode the second tag signals to determine the ownership information.

17. The apparatus of claim 16, wherein the controller is adapted to receive third tag signals from a customer tag via the first interrogator and to decode the third tag signals to determine a customer identifier.

18. The apparatus of claim 17, wherein the ownership information is altered based on the customer identifier.

19. The apparatus of claim 16, wherein the controller comprises a computer and a server adapted to communicate with the computer.

20. A machine readable medium that provides instructions, when executed by a computing platform, cause said computing platform to perform operations comprising a method of:
causing a first interrogator to send a first interrogation signal to a product tag and to a customer tag;
decoding first return signals from the product tag and second return signals from the customer tag to determine information including at least an ownership status of the product and customer information;
completing a transaction based at least in part on the information;
causing the first interrogator to send a write signal to the product tag to change the ownership status for the product included in the transaction;
causing a second interrogator to send a second interrogation signal to the product tag; and decoding a second return signal in response to the second interrogation signal to determine at least the ownership status of the product.

21. The machine readable medium of claim 20, further comprising instructions, which when executed by a computing platform, cause said computing platform to perform further operations of causing the first interrogator to send separate first interrogation signals for the product tag and the customer tag.

22. The machine readable medium of claim 20, wherein the return signal includes a unique identifier.

23. The machine readable medium of claim 20, further comprising instructions, which when executed by a computing platform, cause said computing platform to perform further operations of communicating with a server to obtain additional information to complete the transaction.

24. A machine readable medium that provides instructions, when executed by a computing platform, cause said computing platform to perform operations comprising a method of:
decoding first signals from a first interrogator including item information from an item tag to determine at lest an item identifier;
decoding second signals from the first interrogator including customer information from a customer tag to determine at least an owner identifier;
controlling the first interrogator to send a write signal to the item tag to change an ownership indicator in the item tag based on the owner identifier;
decoding third signals including the item information from a second interrogator to determine at least the ownership indicator.

25. The machine readable medium of claim 24, further comprising instructions, which when executed by a computing platform, cause said computing platform to perform further operations of
decoding fourth signals including the customer information from the second interrogator to determine the owner identifier.

26. The machine readable medium of claim 24, further comprising instructions, which when executed by a computing platform, cause said computing platform to perform further operations of determining if the owner identifier included in the fourth signals matches the ownership identifier in the third signals.

27. The machine readable medium of claim 24, further comprising instructions, which when executed by a computing platform, cause said computing platform to perform further operations of:
comparing the owner identifier included in the fourth signals and the ownership identifier in the third signals; and
issuing an alert if the owner identifier included in the fourth signals does not match the ownership identifier in the third signals.
